(19) United States
(12) Patent Application Publication
(10) Pub. No.: US 2026/0030128 A1
(43) Pub. Date: Jan. 29, 2026

(54) VIRTUALIZATION PERFORMANCE MONITORING METHOD, APPARATUS, DEVICE AND MEDIUM

(71) Applicant: Beijing Volcano Engine Technology Co., Ltd., Haidian District (CN)

(72) Inventor: Zhimin Feng, Beijing (CN)

(21) Appl. No.: 19/057,091

(22) Filed: Feb. 19, 2025

(30) Foreign Application Priority Data
Jul. 29, 2024 (CN) 202411026402.9

(51) Int. Cl. G06F 11/30; G06F 9/455

(52) U.S. Cl. CPC G06F 11/301; G06F 9/45558; G06F 11/3024; G06F 2009/45591

(57) ABSTRACT

The present disclosure relate to a virtualization performance monitoring method and apparatus, a device and a medium, the method comprises: acquiring a first time stamp of a virtual central processing unit VCPU process entering a virtual machine mode and a second time stamp of the VCPU process exiting from the virtual machine mode to a host mode; acquiring a third time stamp of the VCPU process executing a target instruction in the host mode and a fourth time stamp of the VCPU process receiving a wake-up instruction in the host mode, the target instruction being an instruction for causing a CPU to enter a suspended state; determining a CPU usage occupied by the VCPU process running in the host mode based on the first time stamp, the second time stamp, the third time stamp and the fourth time stamp; and determining a virtualization overhead based on the CPU usage.

### CROSS-REFERENCE TO RELATED APPLICATION(S)

This application claims priority to Chinese Application No. 202411026402.9 filed Jul. 29, 2024, the disclosure of which is incorporated herein by reference in its entity.

### FIELD The present disclosure relates to the technical field of computer, and in particular, to a virtualization performance monitoring method, apparatus, device and medium.

### BACKGROUND

The virtualization overhead is one of the key indicators for measuring the performance of the virtual machine. In the related art, the virtualization overhead is mainly determined roughly by a number of times that a VCPU (Virtual Central Processing Unit) exits from a virtual machine mode (which may also be referred to as a virtualization mode or a guest mode) to a host mode (which may also be referred to as a physical machine mode or a host mode) in a unit time, and it is considered that the higher the number of times of the virtualization exit, the greater the virtualization overhead.

### SUMMARY

To solve the above technical problem or at least partially solve the above technical problem, the present disclosure provides a virtualization performance monitoring method, apparatus, device and medium.

In a first aspect, an embodiment of the present disclosure provides a virtualization performance monitoring method, the method comprises: acquiring a first time stamp of a virtual central processing unit (VCPU) process entering a virtual machine mode and a second time stamp of the VCPU process exiting from the virtual machine mode to a host mode; acquiring a third time stamp of the VCPU executing a target instruction in the host mode and a fourth time stamp of the VCPU receiving a wake-up instruction in the host mode; wherein the target instruction is an instruction for causing a CPU to enter a suspended state; determining a CPU usage occupied by the VCPU process running in the host mode based on the first time stamp, the second time stamp, the third time stamp and the fourth time stamp; and determining a virtualization overhead based on the CPU usage.

In a second aspect, an embodiment of the present disclosure further provides a virtualization performance monitoring apparatus, comprising: a first acquisition module, configured to acquire a first time stamp of a VCPU process entering a virtual machine mode and a second time stamp of the VCPU process exiting from the virtual machine mode to a host mode; a second acquisition module, configured to acquire a third time stamp of the VCPU executing a target instruction in the host mode and a fourth time stamp of the VCPU receiving a wake-up instruction in the host mode; wherein the target instruction is an instruction for causing a CPU to enter a suspended state; a CPU usage determination module, configured to determine a CPU usage occupied by the VCPU process running in the host mode based on the first time stamp, the second time stamp, the third time stamp and the fourth time stamp; and a virtualization overhead determination module, configured to determine a virtualization overhead based on the CPU usage.

In a third aspect, an embodiment of the present disclosure further provides an electronic device, the electronic device comprises: a processor; and a memory for storing instructions executable by the processor; the processor is configured to read the executable instructions from the memory and execute the instructions to implement the virtualization performance monitoring method as provided in the embodiments of the present disclosure.

In a fourth aspect, an embodiment of the present disclosure further provides a computer-readable storage medium, the storage medium stores a computer program, and the computer program is used to execute the virtualization performance monitoring method as provided in the embodiments of the present disclosure.

The above technical solution provided by the embodiments of the present disclosure can determine the CPU usage occupied by the VCPU process running in the host mode based on the first time stamp of the VCPU process entering the virtual machine mode, the second time stamp of the VCPU process exiting from the virtual machine mode to the host mode, the third time stamp of the VCPU process executing the target instruction (the instruction for causing the CPU to enter the suspended state) in the host mode, and the fourth time stamp of the VCPU process receiving the wake-up instruction in the host mode, so as to determine the virtualization overhead based on the CPU usage.

It should be understood that the content described in this part is not intended to identify key or important features of the embodiments of the present disclosure, nor is it intended to limit the scope of the present disclosure. Other features of the present disclosure will become readily apparent from the following description.

### BRIEF DESCRIPTION OF THE DRAWINGS

However, the measurement of the virtualization overhead as described in the background is not accurate. In fact, in some special scenarios, there may be a phenomenon that the number of times of the virtualization exit is not large, but the virtualization overhead is relatively large, resulting in inaccurate virtualization performance monitoring results. Therefore, there is an urgent need for a technology that can accurately and reliably monitor the virtualization performance.

The drawings herein are incorporated into the specification and constitute a part of the specification, illustrate embodiments consistent with the disclosure, and are used together with the specification to explain the principle of the disclosure.

In order to more clearly illustrate the technical solutions in the embodiments of the present disclosure or in the prior art, the following will briefly introduce the drawings that need to be used in the description of the embodiments or the prior art. Obviously, for those of ordinary skill in the art, other drawings can also be obtained from these drawings without creative efforts.

FIG. 1 is a schematic flowchart of a virtualization performance monitoring method provided by an embodiment of the present disclosure;

FIG. 2 is a schematic diagram of a principle of determining virtualization overhead provided by an embodiment of the present disclosure;

FIG. 3 is a schematic structural diagram of a virtualization performance monitoring apparatus provided by an embodiment of the present disclosure; and

FIG. 4 is a schematic structural diagram of an electronic device provided by an embodiment of the present disclosure.

### DETAILED DESCRIPTION OF EMBODIMENTS

In order to be able to more clearly understand the above objectives, features and advantages of the present disclosure, the solutions of the present disclosure will be further described below. It should be noted that, in the case where there is no conflict, the embodiments of the present disclosure and the features in the embodiments may be combined with each other.

Many specific details are set forth in the following description so as to fully understand the present disclosure, but the present disclosure may also be implemented in other manners different from those described herein. Obviously, the embodiments in the specification are only a part of embodiments of the present disclosure, but not all embodiments.

With the development of cloud computing, virtualization technology has also evolved from software-emulated virtualization to hardware-assisted virtualization. Hardware-assisted virtualization allows a CPU (Central Processing Unit) to directly execute instructions of a virtual machine (VM) in a virtual machine mode without instruction translation and simulation, so that the performance of the VM is close to that of a physical machine. Considering the security issue, some privileged instructions are not allowed to be directly executed by the CPU in the virtual machine mode. Specifically, the VCPU process running on the CPU is not allowed to execute such privileged instructions in the virtual machine mode, and such instructions must be executed after exiting to a host side. Simulation is completed by a virtual machine monitor VMM, and the virtual machine monitor may also be referred to as virtualization monitoring software. When it comes to the function implementation simulated by the VMM, the VCPU process needs to exit to the host side, and there will be a certain performance overhead, and this kind of performance overhead may usually be referred to as virtualization overhead.

The virtualization overhead is one of the key indicators for measuring the performance of the virtual machine, and the number of times of the virtualization exit may be used to measure the severity of the virtualization overhead. It is generally considered that the more the number of times of the virtualization exit, the greater the virtualization overhead. However, there may be a case that the number of times of the virtualization exit is not large, but the virtualization overhead is relatively large, for example, there is a lock competition scenario in the VMM. The inventors have found through research that if the CPU usage occupied by the VCPU process running on the host side can be obtained accurately, the CPU usage can accurately and objectively measure the virtualization overhead and be used as a quantitative indicator of the virtualization overhead, and on this basis, the virtualization performance can be further accurately and reliably monitored. Based on this, the embodiments of the present disclosure provide a virtualization performance monitoring method, which will be described in detail below for ease of understanding.

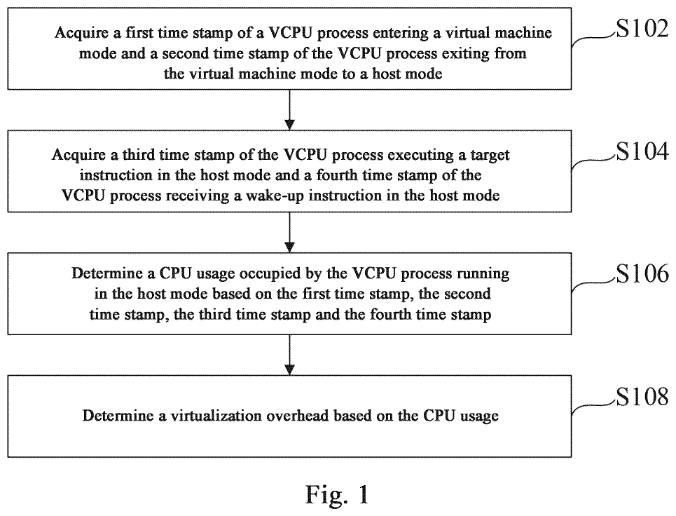

FIG. 1 is a schematic flowchart of a virtualization performance monitoring method provided by an embodiment of the present disclosure. The method may be executed by a virtualization performance monitoring apparatus, and the apparatus may be implemented using software and/or hardware, and may generally be integrated in an electronic device. As shown in FIG. 1, the method mainly comprises the following steps S102 to S108.

In step S102, a first time stamp of a VCPU process entering a virtual machine mode and a second time stamp of the VCPU process exiting from the virtual machine mode to a host mode are acquired.

The VCPU represents a logical processor in the virtual machine, and the CPU will treat the VCPU as a normal process. The virtual machine mode refers to an operating system or an application running in the virtual machine, and accordingly, the host mode refers to an actual physical machine or an operating system running virtualization software. In practical applications, the CPU has two operating states, a non-root mode and a root mode, the virtual machine mode corresponds to the CPU being in the non-root mode, and the host mode corresponds to the CPU being in the root mode. The embodiments of the present disclosure do not limit the manner of acquiring the time stamp. Exemplarily, the time stamp of the current system running may be record by reading a hardware value of a system TSC (Time Stamp Counter), that is, the time stamp is recorded based on the TSC value. It may be assumed that the first time stamp is TSC1 and the second time stamp is TSC2.

In step S104, a third time stamp of the VCPU process executing the target instruction in the host mode and a fourth time stamp of the VCPU process receiving the wake-up instruction in the host mode are acquired. The target instruction is an instruction for causing the CPU to enter a suspended state, such as a privileged instruction such as an HLT instruction or an MWAIT instruction. Similarly, the above time stamps may be recorded by the TSC value. It is assumed that the third time stamp is TSC3 and the fourth time stamp is TSC4. It should be noted that the third time stamp and the fourth time stamp may be acquired or may not be acquired, and if they are not acquired, they are both regarded as zero.

In step S106, the CPU usage occupied by the VCPU process running in the host mode is determined based on the first time stamp, the second time stamp, the third time stamp and the fourth time stamp. The VCPU process is created and managed by the VMM, and the CPU usage occupied by the VCPU process running in the host mode is the CPU usage occupied by the VCPU process executing the VMM code in the host mode, which may also be regarded as the CPU usage proportion of the VMM in the host mode in a unit time.

In practical applications, the above time stamps all affect the CPU usage occupied by the VCPU process running in the host mode, and the CPU usage occupied by the VCPU process executing the VMM code in the host mode is obtained through the difference between the second time stamp and the first time stamp, and the difference between the fourth time stamp and the third time stamp.

In step S108, the virtualization overhead is determined based on the CPU usage. The CPU usage occupied by the VCPU process running in the host mode is positively correlated with the virtualization overhead, that is, the higher the CPU usage occupied by the VCPU process running in the host mode, the higher the virtualization overhead. In practical applications, the CPU usage occupied by the VCPU process running in the host mode may be used as a quantitative indicator of the virtualization overhead, and this manner is more accurate and objective than the manner of using the number of times of the virtualization exit as the quantitative indicator of the virtualization overhead.

In some implementations, when the above-mentioned step of determining the CPU usage occupied by the VCPU process running in the host mode based on the first time stamp, the second time stamp, the third time stamp and the fourth time stamp is implemented, the CPU usage occupied by the VCPU process running in the host mode may be determined based on a first difference between the second time stamp and the first time stamp, and a second difference between the fourth time stamp and the third time stamp.

In practical applications, in the case that the VMM is configured not to intercept the target instruction, the second difference is zero. Specifically, in the case that the VMM is configured not to intercept the target instruction, it may be considered that the third time stamp and the fourth time stamp cannot be obtained, and it is considered that the third time stamp and the fourth time stamp are both zero, that is, the second difference is zero. In the case that the VMM is configured to intercept the target instruction, the third time stamp and the fourth time stamp may be acquired, so the second difference is usually not zero.

In some specific implementations, the above-mentioned step of determining the CPU usage occupied by the VCPU process running in the host mode based on the first difference between the second time stamp and the first time stamp, and the second difference between the fourth time stamp and the third time stamp may refer to the following steps A to C.

In step A, a first duration of the VCPU process running in the virtual machine mode is obtained based on a first difference between the second time stamp and the first time stamp. The first duration is equal to the first difference, and the first duration may also be understood as the time of the VMM running in the virtual machine mode. Assuming that the second time stamp is TSC2 and the first time stamp is TSC1, the first duration delta1=TSC2−TSC1.

In step B, a second duration of the VCPU process being idle in the virtual machine mode is obtained based on a second difference between the fourth time stamp and the third time stamp. The second duration is equal to the second difference. In other words, the second duration may also be understood as the duration of the VCPU process actively releasing the CPU, or understood as the duration of the virtual machine actively releasing the CPU. Assuming that the fourth time stamp is TSC4 and the third time stamp is TSC3, the second duration is delta2=TSC4−TSC3. It should be noted that if the VMM is configured to intercept the target instruction such as the HLT instruction or the MWAIT instruction, that is, the VCPU process executes the target instruction and is intercepted by the VMM and exit to the host mode, and the VCPU process actively releases the CPU resource. In this case, the duration of the VCPU actively releasing the CPU may be obtained, that is, the second duration delta2=TSC4−TSC3 is obtained.

In step C, the CPU usage occupied by the VCPU process running in the host mode is determined based on a sum duration of the first duration and the second duration. In some specific implementations, step C may be performed with reference to the following steps C1 and C2.

In step C1, a target ratio is obtained based on a ratio of a sum duration of the first duration and the second duration to a target duration; wherein the target ratio is equal to a sum of a CPU usage occupied by the VCPU process executing a virtual machine code in the virtual machine mode and a time proportion of the VCPU process actively releasing the CPU. Specifically, the ratio of the first duration to the target duration is the CPU usage occupied by the VCPU process executing the virtual machine code in the virtual machine mode, the ratio of the second duration to the target duration is the time proportion of the VCPU process actively releasing the CPU, and the sum of the two is the target ratio. The target duration is the CPU usage duration of the VCPU process, and the CPU usage may be calculated by calculating the time proportion. For example, the CPU usage occupied by the VCPU process executing the virtual machine code in the virtual machine mode is (delta1+delta2)/t, wherein t is the target duration.

In step C2, the CPU usage occupied by the VCPU process running in the host mode is obtained based on a difference between 1 and the target ratio. The CPU usage occupied by the VCPU process running in the host mode is 1−(delta1+delta2)/t. In other words, 1−(delta1+delta2)/t may be directly used as the virtualization overhead. It may be understood that if the VMM is configured to intercept the target instruction such as the HLT instruction or the MWAIT instruction, the second duration delta2 may not be zero. If the VMM is configured not to intercept the target instruction such as the HLT instruction or the MWAIT instruction, the second duration delta2 must be zero. In this case, the CPU usage occupied by the VCPU process running in the host mode is actually 1−delta1/t, that is, the virtualization overhead is 1−delta1/t.

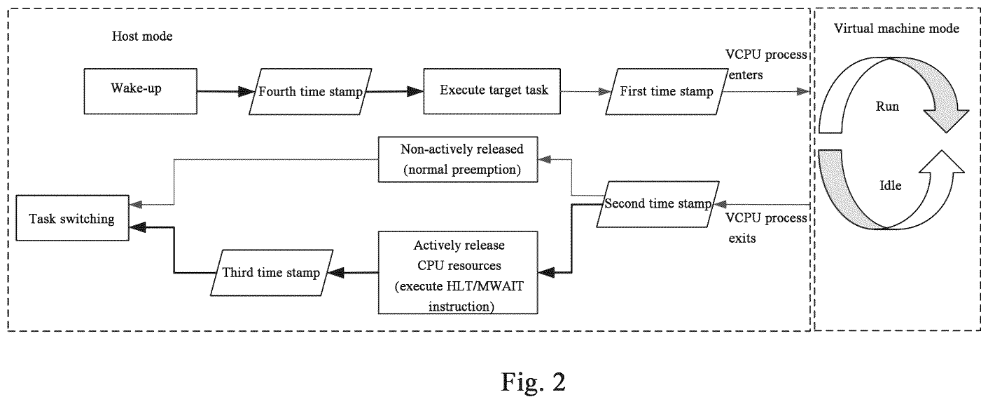

For ease of understanding, referring to a schematic diagram of a principle of determining virtualization overhead shown in FIG. 2, the host mode and the virtual machine mode are illustrated. The first time stamp corresponds to a moment when the VCPU process enters the virtual machine mode, the second time stamp corresponds to a moment when the VCPU process exits from the virtual machine mode, the third time stamp corresponds to a moment when the VCPU process executes the target instruction (HLT/MWAIT instruction), that is, a moment when the VCPU process actively releases the CPU resource, and the fourth time stamp corresponds to a moment when the VCPU process receives the wake-up instruction, that is, a moment when the VCPU process that actively releases the CPU is woken up, and then the target task instructed by the wake-up instruction is executed. It should be noted that when calculating the CPU usage occupied by the VCPU process running in the host mode, it is necessary to consider the case that the VCPU process actively releases the CPU resource (executes the HLT/MWAIT instruction). For the case that the CPU resource is not actively released (normal preemption), the CPU usage will not be affected, and there may be a higher-priority task that needs to be processed on the host, so the corresponding time stamp will not be acquired. FIG. 2 is only a schematic diagram, and finally only task switching is illustrated, and other scheduling points or process switching points may also be included, which will not be illustrated here. Among others, in the case that the VMM is configured to intercept the target instruction such as the HLT instruction or the MWAIT instruction, the third time stamp and the fourth time stamp may be acquired along the black arrow. In the case that the VMM is configured not to intercept the target instruction such as the HLT instruction or the MWAIT instruction, there will be no flow along the black arrow, or it may be understood that even if it is along the black arrow, the third time stamp and the fourth time stamp cannot be acquired, or it may be simply considered that the third time stamp and the fourth time stamp are both zero. In this case, there is no case that the VCPU process actively releases the CPU resource.

In summary, in the above method provided by the embodiments of the present disclosure, the manner of determining the CPU usage occupied by the VCPU process running in the host mode through a plurality of key time stamps is simpler and faster, and the manner of determining the virtualization overhead through the CPU usage is more reasonable and objective, so that a more accurate virtualization overhead can be obtained. In other words, by recording the differences between the time stamps of the VCPU process created by the VMM at several key operating points (scheduling point of actively releasing the CPU, wake-up scheduling point, entering/exiting the virtual machine mode, etc.), the virtualization overhead can be better quantified, and thus the virtualization performance can be accurately and reliably monitored.

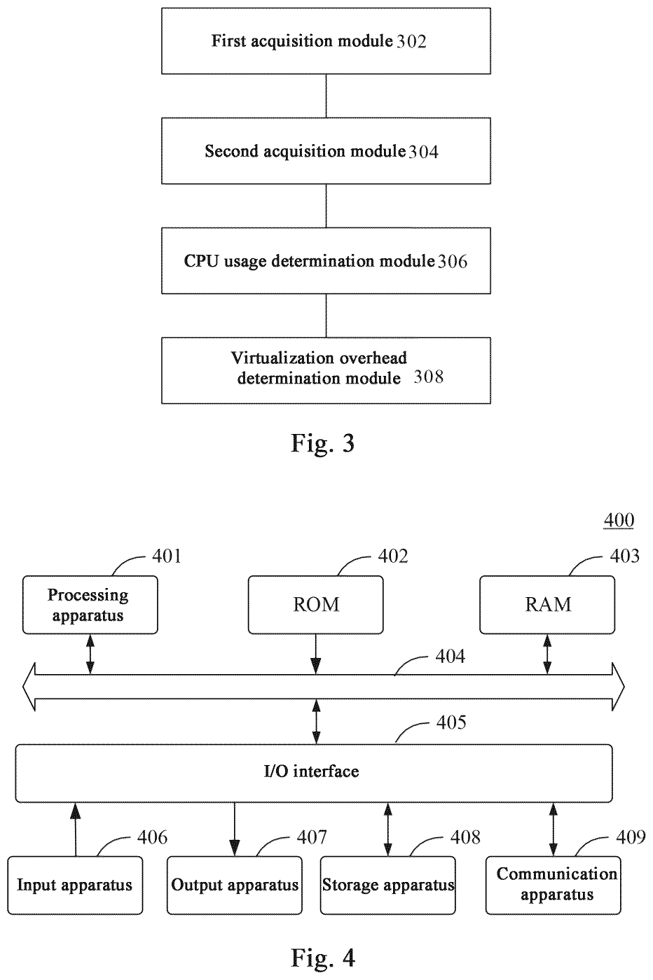

Corresponding to the above virtualization performance monitoring method, an embodiment of the present disclosure further provides a virtualization performance monitoring apparatus. FIG. 3 is a schematic structural diagram of a virtualization performance monitoring apparatus provided by an embodiment of the present disclosure. The apparatus may be implemented in software and/or hardware, and may generally be integrated in an electronic device. As shown in FIG. 3, the virtualization performance monitoring apparatus comprises:
a first acquisition module 302, configured to acquire a first time stamp of a VCPU process entering a virtual machine mode and a second time stamp of the VCPU process exiting from the virtual machine mode to a host mode;
a second acquisition module 304, configured to acquire a third time stamp of the VCPU executing a target instruction in the host mode and a fourth time stamp of the VCPU receiving a wake-up instruction in the host mode; wherein the target instruction is an instruction for causing a CPU to enter a suspended state;
a CPU usage determination module 306, configured to determine a CPU usage occupied by the VCPU process running in the host mode based on the first time stamp, the second time stamp, the third time stamp and the fourth time stamp; and
a virtualization overhead determination module 308, configured to determine a virtualization overhead based on the CPU usage.

The above-mentioned manner of determining the CPU usage occupied by the VCPU process running in the host mode through a plurality of key time stamps is simpler and faster, and the manner of determining the virtualization overhead through the CPU usage is more reasonable and objective, so that a more accurate virtualization overhead can be obtained, thereby ensuring the accuracy and reliability of the virtualization performance monitoring.

In some implementations, the CPU usage determination module 306 is further configured to determine the CPU usage occupied by the VCPU process running in the host mode based on a first difference between the second time stamp and the first time stamp, and a second difference between the fourth time stamp and the third time stamp.

In some implementations, in the case that the virtual machine monitor VMM is configured not to intercept the target instruction, the second difference is zero.

In some implementations, the CPU usage determination module 306 is further configured to obtain a first duration of the VCPU process running in the virtual machine mode based on a first difference between the second time stamp and the first time stamp; obtain a second duration of the VCPU process being idle in the virtual machine mode based on a second difference between the fourth time stamp and the third time stamp; and determine the CPU usage occupied by the VCPU process running in the host mode based on a sum duration of the first duration and the second duration.

In some implementations, the CPU usage determination module 306 is further configured to obtain a target ratio based on a ratio of a sum duration of the first duration and the second duration to a target duration; wherein the target ratio is equal to a sum of a CPU usage occupied by the VCPU process executing a virtual machine code in the virtual machine mode and a time proportion of the VCPU process actively releasing the CPU; the target duration is the CPU usage duration of the VCPU process; and obtain the CPU usage occupied by the VCPU process running in the host mode based on a difference between 1 and the target ratio.

In some implementations, the CPU usage is positively correlated with the virtualization overhead.

The virtualization performance monitoring apparatus provided by the embodiments of the present disclosure may perform the virtualization performance monitoring method provided by any embodiment of the present disclosure, and has corresponding functional modules and beneficial effects of executing the method.

Those of ordinary skill in the art may clearly understand that, for the convenience and simplicity of description, the specific working process of the above-described apparatus embodiments may refer to the corresponding process in the method embodiments, which will not be repeated here.

An embodiment of the present disclosure provides an electronic device, and the electronic device comprises: a storage apparatus storing a computer program thereon; a processing apparatus, configured to execute the computer program in the storage apparatus to implement the steps of any of the methods in the present disclosure.

Reference is made to FIG. 4 below, which illustrates a schematic structural diagram of an electronic device 400 suitable for implementing the embodiments of the present disclosure. The terminal device in the embodiment of the present disclosure may include, but is not limited to, a mobile terminal such as a mobile phone, a laptop, a digital broadcast receiver, a PDA (Personal Digital Assistant), a PAD (tablet computer), a PMP (portable multimedia player), a vehicle-mounted terminal (such as a vehicle navigation terminal), and a fixed terminal such as a digital TV, a desktop computer, etc. The electronic device shown in FIG. 4 is only an example, and should not bring any limitation to the function and usage scope of the embodiments of the present disclosure.

As shown in FIG. 4, the electronic device 400 may include a processing apparatus (such as a central processor, a graphics processor, etc.) 401, which may perform various appropriate actions and processing according to a program stored in a read-only memory (ROM) 402 or a program loaded from a storage apparatus 408 into a random access memory (RAM) 403. Various programs and data required for the operation of the electronic device 400 are also stored in the RAM 403. The processing apparatus 401, the ROM 402 and the RAM 403 are connected to each other through a bus 404. An input/output (I/O) interface 405 is also connected to the bus 404.

Generally, the following apparatus may be connected to the I/O interface 405: an input apparatus 406 including, for example, a touchscreen, a touchpad, a keyboard, a mouse, a camera, a microphone, an accelerometer, a gyroscope, etc. ; an output apparatus 407 including, for example, a liquid crystal display (LCD), a speaker, a vibrator, etc. ; a storage apparatus 408 including, for example, a magnetic tape, a hard disk, etc. ; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all of the illustrated apparatuses. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program codes for executing the method shown in the flowchart. In such an embodiment, the computer program may be downloaded and installed from the network through the communication apparatus 409, or installed from the storage apparatus 408, or installed from the ROM 402. When the computer program is executed by the processing apparatus 401, the above functions defined in the methods of the embodiments of the present disclosure are executed.

In addition to the above methods and devices, an embodiment of the present disclosure may also be a computer program product, which includes computer program instructions that, when executed by a processor, cause the processor to execute the methods provided by the embodiments of the present disclosure. The computer program product may be written in any combination of one or more programming languages for executing the operations of the embodiments of the present disclosure. The programming languages include object-oriented programming languages such as Java, C++, etc., and also include conventional procedural programming languages such as “C” language or similar programming languages. The program codes may be completely executed on the user computing device, partially executed on the user device, executed as an independent software package, partially executed on the user computing device and partially executed on the remote computing device, or completely executed on the remote computing device or server.

In addition, the embodiment of the present disclosure may also be a computer-readable storage medium, which stores computer program instructions thereon, and the computer program instructions, when executed by a processor, cause the processor to execute the virtualization performance monitoring method provided by the embodiment of the present disclosure.

The computer-readable storage medium may be any combination of one or more readable medium. The readable medium may be a readable signal medium or a readable storage medium. The readable storage medium may include, for example, but not limited to, an electrical, magnetic, optical, electromagnetic, infrared, or semiconductor system, apparatus or device, or any combination thereof. More specific examples of the readable storage medium (a non-exhaustive list) include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The embodiment of the present disclosure further provides a computer program product, which includes computer programs/instructions, and when the computer programs/instructions are executed by a processor, the method for determining the virtualization overhead in the embodiment of the present disclosure is implemented.

It may be understood that, before using the technical solutions disclosed in the embodiments of the present disclosure, the user should be informed of the type, usage scope, usage scenario, etc. of the personal information involved in the present disclosure through an appropriate manner according to relevant laws and regulations, and the user's authorization should be obtained.

For example, in response to receiving an active request from the user, prompt information is sent to the user to explicitly prompt the user that the operation requested to be performed will require acquisition and use of the user's personal information. Thus, the user can independently select whether to provide personal information to software or hardware such as an electronic device, an application, a server, or a storage medium that performs the operation of the technical solution of the present disclosure according to the prompt information.

As an optional but non-limiting implementation, the manner of sending the prompt information to the user in response to receiving the active request from the user may be, for example, a pop-up window, and the prompt information may be presented in the pop-up window in a text manner. In addition, the pop-up window may also carry a selection control for the user to select “consent”or “disagree”to provide personal information to the electronic device.

It can be understood that the above process of notifying and obtaining user authorization is only illustrative, and does not constitute a limitation on the implementations of the present disclosure, and other manners that meet relevant laws and regulations may also be applied to the implementations of the present disclosure.

It should be noted that, in this document, relational terms such as “first” and “second” are only used to distinguish one entity or operation from another entity or operation, and do not necessarily require or imply that there is any such actual relationship or order between these entities or operations. Moreover, the term “include/comprise” or any other variation thereof is intended to cover a non-exclusive inclusion, such that a process, method, article or device that includes a list of elements not only includes those elements, but also includes other elements not expressly listed, or also includes elements inherent to such process, method, article or device. Without more limitations, an element defined by the phrase “include/comprise one . . .” does not exclude that there are other same elements in the process, method, article or device that includes the element.

The above are only specific implementations of the present disclosure, and enable those skilled in the art to understand or implement the present disclosure. Various modifications to these embodiments will be obvious to those skilled in the art, and the general principles defined herein may be implemented in other embodiments without departing from the spirit or scope of the present disclosure. Therefore, the present disclosure will not be limited to these embodiments described herein, but is to be accorded the widest scope consistent with the principles and novel features disclosed herein.

I/We claim:

1. A virtualization performance monitoring method, comprising:
acquiring a first time stamp of a virtual central processing unit VCPU process entering a virtual machine mode and a second time stamp of the VCPU process exiting from the virtual machine mode to a host mode;
acquiring a third time stamp of the VCPU process executing a target instruction in the host mode and a fourth time stamp of the VCPU process receiving a wake-up instruction in the host mode, wherein the target instruction is an instruction for causing a CPU to enter a suspended state;
determining a CPU usage occupied by the VCPU process running in the host mode based on the first time stamp, the second time stamp, the third time stamp and the fourth time stamp; and
determining a virtualization overhead based on the CPU usage.

2. The method according to claim 1, wherein determining the CPU usage occupied by the VCPU process running in the host mode based on the first time stamp, the second time stamp, the third time stamp and the fourth time stamp comprises:
determining the CPU usage occupied by the VCPU process running in the host mode based on a first difference between the second time stamp and the first time stamp, and a second difference between the fourth time stamp and the third time stamp.

3. The method according to claim 2, wherein in a case that a virtual machine monitor VMM is configured not to intercept the target instruction, the second difference is zero.

4. The method according to claim 2, wherein determining the CPU usage occupied by the VCPU process running in the host mode based on the first difference between the second time stamp and the first time stamp, and the second difference between the fourth time stamp and the third time stamp comprises:
obtaining a first duration of the VCPU process running in the virtual machine mode based on the first difference between the second time stamp and the first time stamp;
obtaining a second duration of the VCPU process being idle in the virtual machine mode based on the second difference between the fourth time stamp and the third time stamp; and
determining the CPU usage occupied by the VCPU process running in the host mode based on a sum duration of the first duration and the second duration.

5. The method according to claim 4, wherein determining the CPU usage occupied by the VCPU process running in the host mode based on the sum duration of the first duration and the second duration comprises:
obtaining a target ratio based on a ratio of the sum duration of the first duration and the second duration to a target duration, wherein the target ratio is equal to a sum of a CPU usage occupied by the VCPU process executing a virtual machine code in the virtual machine mode and a time proportion of the VCPU process actively releasing the CPU, the target duration being a CPU usage duration of the VCPU process; and
obtaining the CPU usage occupied by the VCPU process running in the host mode based on a difference between 1 and the target ratio.

6. The method according to claim 5, wherein the CPU usage occupied by the VCPU process executing a virtual machine code in the virtual machine mode is a ratio of the first duration to the target duration, and the time proportion of the VCPU process actively releasing the CPU is a ratio of the second duration to the target duration.

7. The method according to claim 1, wherein the CPU usage is positively correlated with the virtualization overhead.

8. An electronic device, comprising:
a storage apparatus, storing a computer program thereon;
a processing apparatus, configured to execute the computer program in the storage apparatus to:
acquire a first time stamp of a virtual central processing unit VCPU process entering a virtual machine mode and a second time stamp of the VCPU process exiting from the virtual machine mode to a host mode;
acquire a third time stamp of the VCPU process executing a target instruction in the host mode and a fourth time stamp of the VCPU process receiving a wake-up instruction in the host mode, wherein the target instruction is an instruction for causing a CPU to enter a suspended state;
determine a CPU usage occupied by the VCPU process running in the host mode based on the first time stamp, the second time stamp, the third time stamp and the fourth time stamp; and
determine a virtualization overhead based on the CPU usage.

9. The electronic device according to claim 8, wherein the computer program to determine the CPU usage occupied by the VCPU process running in the host mode based on the first time stamp, the second time stamp, the third time stamp and the fourth time stamp comprises instructions to:
determine the CPU usage occupied by the VCPU process running in the host mode based on a first difference between the second time stamp and the first time stamp, and a second difference between the fourth time stamp and the third time stamp.

10. The electronic device according to claim 9, wherein in a case that a virtual machine monitor VMM is configured not to intercept the target instruction, the second difference is zero.

11. The electronic device according to claim 9, wherein the computer program to determine the CPU usage occupied by the VCPU process running in the host mode based on the first difference between the second time stamp and the first time stamp, and the second difference between the fourth time stamp and the third time stamp comprises instructions to:
obtain a first duration of the VCPU process running in the virtual machine mode based on the first difference between the second time stamp and the first time stamp;
obtain a second duration of the VCPU process being idle in the virtual machine mode based on the second difference between the fourth time stamp and the third time stamp; and
determine the CPU usage occupied by the VCPU process running in the host mode based on a sum duration of the first duration and the second duration.

12. The electronic device according to claim 11, wherein the computer program to determine the CPU usage occupied by the VCPU process running in the host mode based on the sum duration of the first duration and the second duration comprises instructions to:
obtain a target ratio based on a ratio of the sum duration of the first duration and the second duration to a target duration, wherein the target ratio is equal to a sum of a CPU usage occupied by the VCPU process executing a virtual machine code in the virtual machine mode and a time proportion of the VCPU process actively releasing the CPU, the target duration being a CPU usage duration of the VCPU process; and
obtain the CPU usage occupied by the VCPU process running in the host mode based on a difference between 1 and the target ratio.

13. The electronic device according to claim 12, wherein the CPU usage occupied by the VCPU process executing a virtual machine code in the virtual machine mode is a ratio of the first duration to the target duration, and the time proportion of the VCPU process actively releasing the CPU is a ratio of the second duration to the target duration.

14. The electronic device according to claim 8, wherein the CPU usage is positively correlated with the virtualization overhead.

15. A non-transitory computer-readable storage medium, wherein the storage medium stores a computer program, and the computer program is used to:
acquire a first time stamp of a virtual central processing unit VCPU process entering a virtual machine mode and a second time stamp of the VCPU process exiting from the virtual machine mode to a host mode;
acquire a third time stamp of the VCPU process executing a target instruction in the host mode and a fourth time stamp of the VCPU process receiving a wake-up instruction in the host mode, wherein the target instruction is an instruction for causing a CPU to enter a suspended state;
determine a CPU usage occupied by the VCPU process running in the host mode based on the first time stamp, the second time stamp, the third time stamp and the fourth time stamp; and
determine a virtualization overhead based on the CPU usage.

16. The storage medium according to claim 15, the computer program to determine the CPU usage occupied by the VCPU process running in the host mode based on the first time stamp, the second time stamp, the third time stamp and the fourth time stamp comprises instructions to:
determine the CPU usage occupied by the VCPU process running in the host mode based on a first difference between the second time stamp and the first time stamp, and a second difference between the fourth time stamp and the third time stamp.

17. The storage medium according to claim 16, wherein in a case that a virtual machine monitor VMM is configured not to intercept the target instruction, the second difference is zero.

18. The storage medium according to claim 16, wherein the computer program to determine the CPU usage occupied by the VCPU process running in the host mode based on the first difference between the second time stamp and the first time stamp, and the second difference between the fourth time stamp and the third time stamp comprises instructions to:
obtain a first duration of the VCPU process running in the virtual machine mode based on the first difference between the second time stamp and the first time stamp;
obtain a second duration of the VCPU process being idle in the virtual machine mode based on the second difference between the fourth time stamp and the third time stamp; and
determine the CPU usage occupied by the VCPU process running in the host mode based on a sum duration of the first duration and the second duration.

19. The storage medium according to claim 18, wherein the computer program to determine the CPU usage occupied by the VCPU process running in the host mode based on the sum duration of the first duration and the second duration comprises instructions to:
obtain a target ratio based on a ratio of the sum duration of the first duration and the second duration to a target duration, wherein the target ratio is equal to a sum of a CPU usage occupied by the VCPU process executing a virtual machine code in the virtual machine mode and a time proportion of the VCPU process actively releasing the CPU, the target duration being a CPU usage duration of the VCPU process; and
obtain the CPU usage occupied by the VCPU process running in the host mode based on a difference between 1 and the target ratio.

20. The storage medium according to claim 15, wherein the CPU usage is positively correlated with the virtualization overhead.
